(19) United States
(12) Patent Application Publication
(10) Pub. No.: US 2025/0174143 A1
(43) Pub. Date: May 29, 2025

(54) System for a Cloud-based Intelligent Tutoring System (ITS) using an Artificial Intelligence Engine

(71) Applicant: Southern University and A&M College, Baton Rouge, LA (US)

(72) Inventor: Tapan Sarkar, Baton Rouge, LA (US)

(73) Assignee: Southern University and A&M College, Baton Rouge, LA (US)

(21) Appl. No.: 18/433,800

(22) Filed: Feb. 6, 2024

Related U.S. Application Data
(63) Continuation-in-part of application No. 18/521,928, filed on Nov. 28, 2023.

(51) Int. Cl. G09B 7/04; G06F 40/40

(52) U.S. Cl. CPC G09B 7/04; G06F 40/40

(57) ABSTRACT

An AI-based Intelligent Tutoring System (ITS) that assists teachers in designing learning activities for students inside a classroom and collecting students' participation and performance data via personal mobile phones to a cloud-based computing system. The invention uses artificial intelligence to evaluate the participation and performance data to create personalized tutoring plans that are provided to students' mobile phones outside the classroom, allowing them to learn at their own pace and time. The AI-powered ITS of the invention continuously monitors students' learning outcomes inside and outside the classroom and supplements classroom learning by individualized tutoring outside the classroom using their mobile phones, until mastery of the topic is achieved. Depending on the volume of the learning material to be provided or for students who are visually challenged, the innovation can switch from text to voice. It leverages text-based access to the Internet without the need for expensive infrastructure.

### CROSS REFERENCE TO RELATED APPLICATION

The present application claims priority to and is a continuation in-part of U.S. application Ser. No. 18/521,928, filed Nov. 28, 2023, the contents of which are fully incorporated herein.

### FIELD OF THE INVENTION

The present invention relates to a cloud-based Intelligent Tutoring System (ITS) using an Artificial Intelligence (AI) engine.

### BACKGROUND

The objective of Bloom's taxonomy of educational is a hierarchical ordering of skills in different domains whose primary use is to help teachers teach and students learn effectively and efficiently. Benjamin Bloom's taxonomy of educational objectives include the concept of “mastery learning.” Mastery learning emphasizes the importance of individualized instruction and providing students with the necessary support to achieve mastery. Mastery learning can bring about several improvements in student learning including higher levels of achievement by personalized tutoring.

Notably, individual student progress can vary based on various factors, including their prior knowledge, effort, motivation, and other contextual variables. Though the massive benefit of one-to-one tutoring is well known (e.g., one teacher instructing one student), one-to-one tutoring cannot be practically deployed because the number of students drastically outnumbers the available teachers.

Prior to the popularity of using personalized hand-held devices, the availability of tutoring a plurality of students simultaneously was limited. In addition, before the wide availability of the integration of Artificial Intelligence (AI) as application programming interface (API) into ITS applications, computer based tutoring systems suffered from availability, time and capability constraints of the human teacher creating the domain model of learning and in assessing student progress. What is needed is a learning model that can tutor a plurality of students that makes use of AI and diminishes the need for one-to-one teacher to student instruction.

### SUMMARY OF THE INVENTION

The present invention teaches a tutoring model having a mobile phone or other personal computing device available to and controlled by a student, wherein the personal computing device may be used to respond to classroom engagement activities, such as, responding classroom attendance checks, providing quiz-answers. The personal computing device may be used for both text and voice interface for visually impaired, or for text or voice singly. In one embodiment, the personal computing device may be device configured to or delivery of long content by voice unsuitable for mobile phones. The invention discloses storing and accessing data from cloud-based hosted database without having the Internet infrastructure. The invention further teaches using the personal computing device for personalized education at inside and outside the classrooms by employing interactive messaging with aided by a cloud-based the AI engine (e.g. ‘what assignments are outstanding?’, ‘what is my current grade?’). In addition, the invention teaches using the personal computing device to seamlessly collect data on student individual performance. The invention also discloses using Artificial Intelligence for building the intelligent conversations like a human teacher for assessing a student's mood and learning habits. Even further, the invention teaches using the AI engine to measure a student's individual capabilities or learning style with the ability to dynamically changing the pedagogy taking into account various learning theories, such as, scaffolding, transformative learning, humanism learning, cognitive learning, behaviorism learning, and be like. In accordance with various embodiments of the invention, the AI engine prepares personalized tutoring plans based on the pedagogy desired for the individual student.

An AI-based Intelligent Tutoring System (ITS) that assists teachers in designing learning activities for the students inside the classroom and collecting students' participation and performance data from these activities (e.g. attendance, quizzes, class tests, brainstorming, polling) via personal mobile phones to a cloud-based computing system. The invention uses artificial intelligence to evaluate such classroom participation and performance data in order to create personalized tutoring plans that are provided to students' mobile phones outside the classroom, allowing them to learn at their own pace and time. Thus, the AI-powered ITS of the invention continuously monitors students' learning outcomes inside and outside of the classroom and supplements classroom learning by individual tutoring outside the classroom using their mobile phones, until mastery of the topic is achieved. Depending on the volume of the learning material to be provided or for students who are visually challenged, the innovation can switch from text to voice. It leverages text-based access to the Internet without the need for expensive infrastructure.

As such, the present invention allows teachers to gauge the effectiveness of their lectures and assess student comprehension levels and learning progress, even in real-time. Such evaluations allow the teacher to make informed decisions regarding their teaching approach, and to identify the strengths and weaknesses of each student from both in-class and out-of-class environment.

The present invention uses AI to build an ITS that employs various pedagogical learning methods to develop dynamically tailored tutoring plans to each individual student's learning needs. In various embodiments, the present invention uses AI to dynamically addresses four modules: (1) the content to be taught, (2) an understanding the student's ability to learn specific subject matter, (3) the optimal pedagogy to be used for the student, and (4) the correct interface required for the dynamic tutoring depending on the ability of a plurality of learners to learn visually or through voice. The invention teaches dynamically switching from voice to text and vice-versa for out-of-the class tutoring with or without the presence of a human teacher. The invention teaches using a student's stored historical performance data to provide content for dynamically preparing content for use in tutoring.

In one aspect, the present system includes an ITS that uses mobile technology to facilitate student learning. For example, mobile devices communicating with cloud computing services may send and receive data from a cloud-based processor using SMS and MMS messaging, such as A2P 10-digit long code systems or 10 DLC systems, using for example, A2P 10-digit long phone numbers, employed by mobile phone carriers, or web-hooking technology (e.g., using web hook URLs integration and automation). The present invention provides distinct personalized learning experiences to a plurality of learners of various abilities, including the visually impaired, using mobile phones. In one example, the invention uses the unique phone number associated with a mobile device controlled by a student to exchange data and provide personalized tutoring services to engage the student in classroom activities. ITS The invention may use text-based web-hooking technology to facilitate communications between a mobile device and an AI engine using text messaging. Therefore, the invention minimizes the use of costly infrastructure since the conventional Internet connection is not necessary. Present invention is designed to provide learners with immediate and personalized instruction or feedback without the need for human teachers. The invention provides class-engagement tools for one-to-many instruction from a single instructor (e.g., for classroom lectures) or for tutoring anywhere outside the classrooms with no teacher at all (online homework).

In another aspect, the present invention utilizes mobile computing devices and AI to dynamically design the content for learning (a “tutoring plan”), for the interactive learning process based on immediate responses from the students, for continuous instant feedback and assessments to enable a comprehensive personalized learning experience, and for allowing learners to achieve desired high level of proficiency across the plurality of learning topics as determined by the plurality of teachers or plurality of the learning authorities that is deployed. Examples of such educational authorities are Board of Regions, AACSB (Association of Advance Collegiate Schools of Business), ABET (Accreditation Board for Engineering and Technology).

Furthermore, the invention enables teachers or teaching administrators to provide teaching objective and prior stored learning outcomes to an AI engine for content modeling, measure learning outcomes and gauging student comprehension through learning modules (datafiles containing learning objectives”). Consequently, the system removes the conventional layers of learning by automatically and by on demand gathering up-to-date learning materials, incorporating a dynamic just-in-time pedagogy based on the learners' environment and capabilities, and continuously judging the individual learner's concentration, mood, or willingness to learn that is always present in a human teacher student interaction. The present invention not only eliminates the need for a human teacher in the pedagogical process but the present invention also uses AI to dynamically acquire up-to-date knowledge from Internet sources. The present invention uses the up-to-date knowledge to determine the most effective just-in-time pedagogy based on the content gleaned from the internet sources.

Unlike existing tutoring systems, the present invention does not start tutoring the plurality of students without the classroom or student's individual historical performance data. Instead, the current invention, stores the classroom scholastic performance, and the individual student's scholastic performance data, and analyzes the scholastic performance data using an AI engine. The invention uses historical scholastic performance data to design tutoring plans for students inside and outside the classroom. In one embodiment, a new tutoring plan may be prepared when the student, or plurality of students, attends the next class and confirms his learning by interacting with classroom activities (e.g., tests, quizzes, polls, brainstorming activities, etc.). The content of tutoring may remain unchanged from the class before, but the pedagogy may change as determined by the AI engine to optimize later tutoring inside and outside the class.

The present invention collects and delivers the learning content by evaluating the up-to-date knowledge in light of the diversity of learners' abilities, which continually shifts during the learning process.

In one aspect, the invention allows the teacher to continuously monitor student participation and performance in classroom activities, and to prepare tutoring plans personalized to each student, where the tutoring plan is prepared by 1) initiating learning and attendance modules stored in the relational database, 2) requiring the student to provide responses to the learning and attendance modules using a student's personal mobile device, and 3) analyzing the student responses using a cloud-based artificial engine. The cloud-based artificial intelligence engine may analyze the attendance and performance information to design tutoring plans individualized to each student to supplement classroom learning until mastery of the topic is achieved. Further, the teacher may use the artificial intelligence analysis to better prepare learning objective suited for the classroom.

In yet another embodiment of the invention, a system for taking classroom attendance of a plurality of students located inside a classroom is disclosed, comprising:
a. a first classroom computer for generating a take attendance signal, wherein the first classroom computer is located inside a classroom;
b. a cloud-based processor for receiving the take attendance signal, the cloud-based processor generating a confirm attendance code in response to the take attendance signal;
c. a cloud-based artificial intelligence (AI) engine for receiving the confirm attendance code, wherein the cloud-based artificial intelligence engine generates an attendance check code in response to receiving the confirm attendance code;
d. a second classroom computer for receiving the attendance check code, wherein the second classroom computer provides the attendance check code;
e. a projector for receiving the attendance check code and displaying the attendance check code to be visually seen by a plurality of students in the classroom;
f. a timer for counting down time from a predetermined time to zero time when the attendance check code is displayed;
g. A plurality of mobile devices for providing a distinct plurality of responding attendance check codes to the cloud-based processor before the timer is at zero time, wherein each one of the plurality of mobile devices provides the distinct one of the plurality of attendance check codes to the cloud-based processor, wherein at least one of the plurality of mobile devices is being activated by a distinct one of the plurality of students in the classroom to send the distinct one of the plurality of responding attendance check codes, wherein the cloud-based processor compares the distinct one of the plurality of responding attendance check codes to the attendance check code to produce a comparison result; and
h. A cloud-based relational database for receiving the comparison result and storing the comparison result in the cloud-based relational database, wherein the cloud-based relational database includes at least one storage area corresponding to the each one of the plurality of students in the classroom, wherein storing the comparison result includes storing the comparison result in a distinct storage area of the cloud-based relational database corresponding to at least one of the plurality of students in the classroom.

In yet another embodiment of the invention, a system for taking classroom attendance of a plurality of students located inside a classroom is disclosed, comprising:
a. a third classroom computer for generating a second take attendance signal, wherein the third classroom computer is located inside a second classroom, wherein the cloud-based processor receives the second take attendance signal, the cloud-based processor generating a second confirm attendance code in response to the second take attendance signal, wherein the cloud-based artificial intelligence (AI) engine receives the second confirm attendance code, wherein the cloud-based artificial intelligence engine generates a second attendance check code in response to receiving the second confirm attendance code;
b. a third classroom computer for receiving the attendance check code, wherein the third classroom computer provides the second attendance check code;
c. a second projector for receiving the second attendance check code and displaying the second attendance check code to be visually seen by a second plurality of students in the second classroom;
d. a second timer for counting down time from a predetermined time to zero time when the second attendance check code is displayed;
e. a second plurality of mobile devices for providing a second distinct plurality of responding attendance check codes to the cloud-based processor before the second timer is at zero time, wherein each one of the second plurality of mobile devices provides the second distinct one of the plurality of attendance check codes to the cloud-based processor, wherein at least one of the second plurality of mobile devices is being activated by a distinct one of the second plurality of students in the classroom to send the second distinct one of the plurality of responding attendance check codes, wherein the cloud-based processor compares the second distinct one of the plurality of responding attendance check codes to the second attendance check code to produce a second comparison result, wherein the cloud-based relational database for receives the second comparison result and stores the second comparison result in the cloud-based relational database, wherein the cloud-based relational database includes at least one storage area corresponding to the each one of the second plurality of students in the second classroom, wherein storing the second comparison result includes storing the second comparison result in a distinct storage area of the cloud-based relational database corresponding to at least one of the second plurality of students in the classroom, wherein the cloud-based processor aggregates the first comparison result and the second comparison result into an aggregated comparison result, wherein the cloud-based relational database receives the aggregate comparison result and stores the aggregate comparison result in the cloud-based relational database, wherein storing the aggregate comparison result includes storing the aggregate comparison result in the distinct storage area of the cloud-based relational database corresponding to the at least one of the second plurality of students in the classroom.

### BRIEF DESCRIPTION OF THE DRAWINGS

A more complete understanding of the present invention may be derived by referring to the various embodiments of the invention described in the detailed descriptions and drawings and figures in which like numerals denote like elements, and in which:

FIG. 1 is an exemplary embodiment of an Intelligent Tutoring System for use in taking attendance according to various embodiments of the present invention;

FIG. 2 is an exemplary depiction providing an attendance check code to a student mobile device in accordance with the present invention;

FIG. 3 depicts an exemplary method of taking attendance using the Intelligent Tutoring System in accordance with the present invention;

FIG. 4 is an exemplary embodiment of an Intelligent Tutoring System for use in a student learning session according to various embodiments of the present invention;

FIG. 5 is an exemplary depiction providing a real-time quiz questions to a student mobile device in accordance with the present invention;

FIG. 6 depicts an exemplary method of providing real-time quiz questions to a student mobile device using the Intelligent Tutoring System in accordance with the present invention;

FIG. 7 is an exemplary embodiment of an Intelligent Tutoring System for use conducting a brainstorming session according to various embodiments of the present invention;

FIG. 8 is an exemplary depiction providing brainstorming questions to a student mobile device in accordance with the present invention;

FIG. 9 depicts an exemplary method of conducting a brainstorming session using the Intelligent Tutoring System in accordance with the present invention;

FIG. 10 is an exemplary embodiment of an Intelligent Tutoring System for use in polling students according to various embodiments of the present invention;

FIG. 11 is an exemplary depiction providing a polling question to a student mobile device in accordance with the present invention;

FIG. 12 depicts an exemplary method of conducting a polling session using the Intelligent Tutoring System in accordance with the present invention; and

FIG. 13 is an exemplary classroom enrollment file according to the present invention.

### DETAILED DESCRIPTION OF THE INVENTION

It should be appreciated that the particular embodiments shown and described herein are illustrative of the invention and its best mode and are not intended to otherwise limit the scope of the present invention in any way. Indeed, for the sake of brevity, conventional wireless data transmission, voice-to-text and text-to-voice messaging and interfaces, transmitter, receivers, baseband transmitters or receivers, cell towers, modulators, base stations, data transmission concepts, cell phones, mobile phones, analog or digital projectors and projector screens and other functional aspects of the systems (and components of the individual operating components of the systems) may not be described in detail herein. Furthermore, the connecting lines shown in the various figures contained herein are intended to represent exemplary functional relationships and/or physical couplings between the various elements. It also should be noted that many alternative or additional functional relationships or physical connections may be present in a practical electronic transaction or datafile transmission system.

As will be appreciated by one of ordinary skill in the art, the present invention may be embodied as a method, a system, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, cloud-storage, magnetic storage devices, and/or the like.

The present invention uses conventional data transmission techniques for wirelessly transmitting data using cloud computing services, such as, cloud-based databases (cloud storage device), cloud-based servers, cloud-based processors, etc. The present invention teaches transmitting data using a mobile data network and webhook technology for interfacing with a mobile phone service providers to connect to the internet, and for exchanging data between the internet and the mobile device (e.g., using, for example, webhook URLs). For example, according to various embodiments of the invention, a computer may include software or artificial intelligence engines which interfaces with a cloud-based processor or a cloud-based storage device for securely storing the data using, for example, SMS or Text to URL applications. As is well known, the cloud employs various data encryption and authentication protocols to maintain security during transmission. Once data is uploaded to the cloud, a mobile device (e.g, mobile phone) may connect to the cloud computing services through an internet connection or mobile network. The present invention uses conventional authentication mechanisms to ensure that only authorized users can access the stored data. The cloud computing services are configured to process the request from the mobile phone and, if authorized, initiates the data transfer. This process typically involves data packets being broken down, transmitted over the network, and reassembled on the mobile phone.

The present invention also discloses a teacher preparing learning objectives. The present invention further teaches an artificial intelligence engine preparing a tutoring plan. According to this invention a tutoring plan includes personalized pedagogy having content related to the learning objectives, scaffolding, tests and responses for tutoring. The personalized tutoring plans prepared by the AI engine may further include personalized conversations allowing the student to interact with the AI engine using voice or text, such as, using natural language communications. In preparing the tutoring plan, the AI engine uses the student's attendance data, and further determines the student's strengths and weaknesses based on student past academic performance. Data regarding the students past academic performance may be stored in the relational database as described more fully below. The personalized tutoring plans according to the invention are delivered to the student's personal mobile device. The student may interact with the AI engine for tutoring using the mobile device interface.

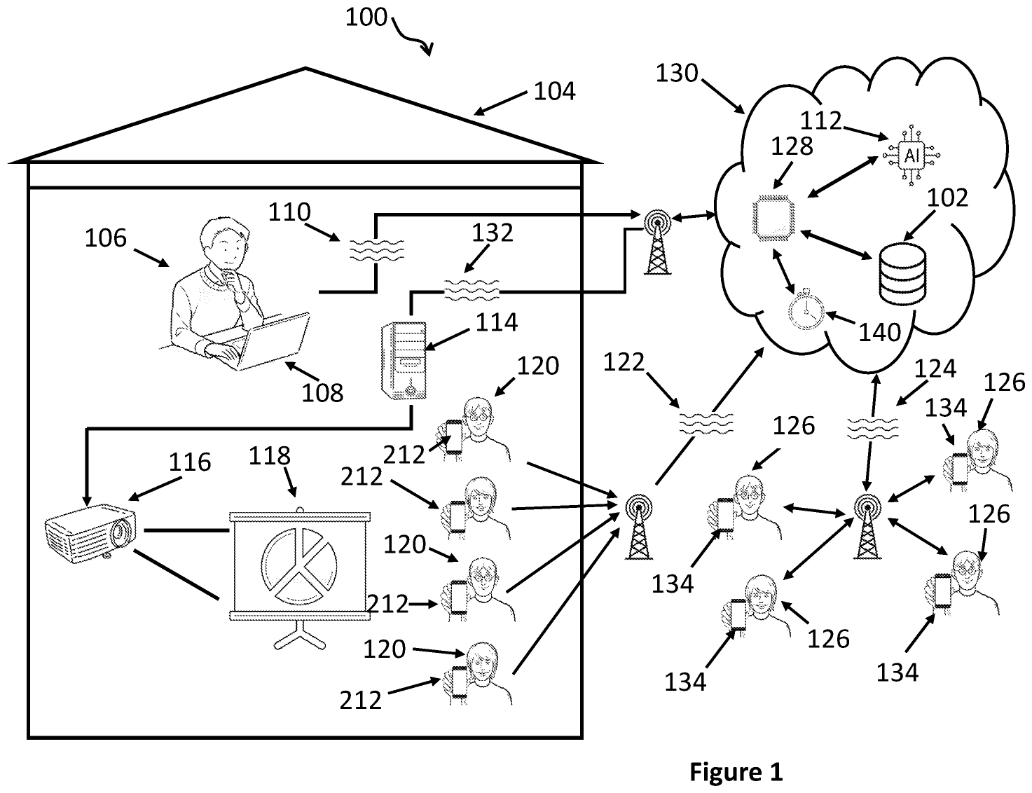

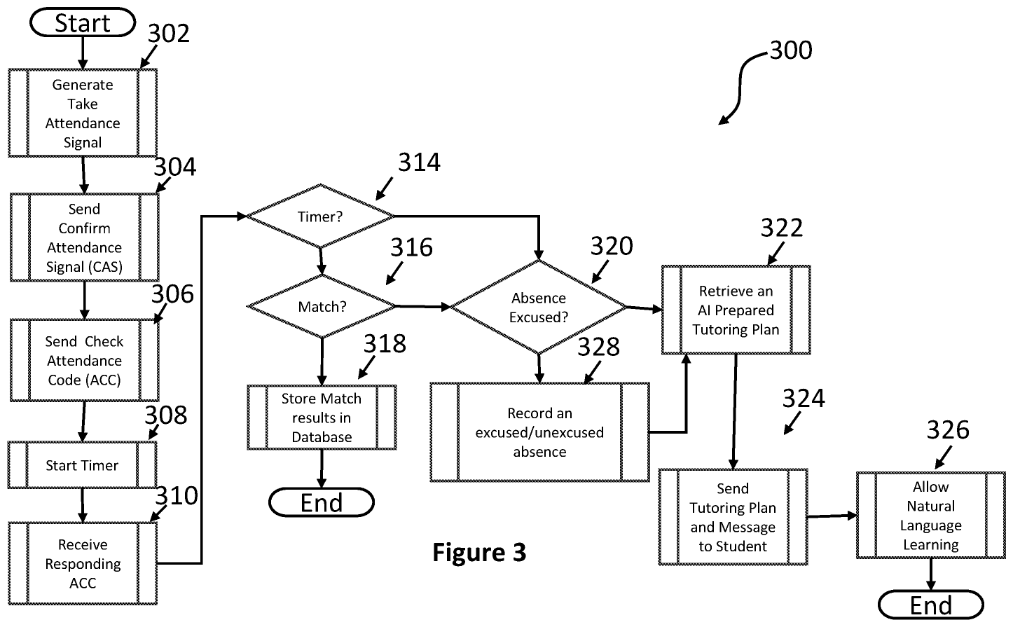

FIGS. 1-3 depict an exemplary computer based intelligent tutoring system (ITS) 100 according to the various embodiments of the present invention configured to calculate the number of students in a classroom environment. As shown in FIG. 1, teacher 106 is in a classroom 104. Teacher 106 is depicted controlling a first computer 108 where the computing device 108 is further in communication with a cloud computing system 130. Cloud computing system 130 includes a cloud-based processor 128, which is in communication with an AI engine 112 and further in communication with a cloud-based relational database 102. Cloud-based processor 128 is depicted in communication with a timer 140 for use in controlling the time during which cloud-based processor 128 may perform computer instructions. Teacher 106 may use first computer 108 to data signals cloud-based processor 128 for controlling the operation of cloud-based processor 128. Teacher 106 may further use first computer 108 to send data signals cloud-based processor 128 for instructing the cloud-based processor 128 to exchange data filed with an AI engine 112 and with a relational database 102.

As used herein, classroom 104 may include students who are not physically in classroom 104, but are participating in the classroom activities online (e.g., hybrid classrooms). In such instances, students participating online may be provided the same data provided to students inside classroom 104. The data may be provided to a computing device controlled by students outside the classroom 104 but that are participating online. Such students may participate online if, for example, the students have provided a matching responding check attendance code 122 as discussed herein.

Cloud-based processor 128 may be in further communication with a second computing system 114 for exchanging data with cloud-based processor 128. Second computing system 114 may be located within classroom 104. Second computing system 114 may be in further communication with a projector 116. Projector 116 may be configured to provide data received from second computing system 114 to a projector screen 118. The data displayed on projector screen 118 may be seen by the students 120 when the students 120 are physically located within classroom 104. In a hybrid classroom 104, data from cloud-based processor may be seen by students online, such as when the data is displayed on a computing device controlled by the online student.

As used herein, a classroom may be any conventional room in which students are taught. Classroom 104 may include one or more students 120 inside the classroom environment. Students 120 may be individually controlling a personal computing device, such as, a mobile device 212. Each one of the students 120 may individually control their own distinct mobile device 212 to exchange data with cloud computing system 130. Each one of the students 120 may individually control a distinct mobile device 212 to exchange data with cloud-based processor 128. Cloud-based processor 128 may exchange data with distinct mobile device 212 and with AI engine 112. Cloud-based processor 128 may exchange data signal exchange data mobile devices 212 and provide the exchanged data to relational database 102.

In another exemplary embodiment, students 126 may be located outside classroom 104. Each one of the students 126 may individually control their own distinct mobile devices 134 for exchanging data with cloud-based processor 128. Cloud-based processor 128 may be configured to receive data from mobile devices 134 and provide the received data to AI engine 112. Further, Cloud-based processor 128 may receive the data from distinct mobile devices 134 and provide the data to relational database 102. Cloud-based processor 128 may be configured to communicate with AI engine 112 and relational database 102 to provide a data cloud-based process 128 receives from mobile devices 134.

The invention may use any conventional methods for exchanging data between first computer 108, cloud-based processor 128, AI engine 112, relational database 102, projector 116, mobile devices 212, mobile devices 134 or cloud system 130.

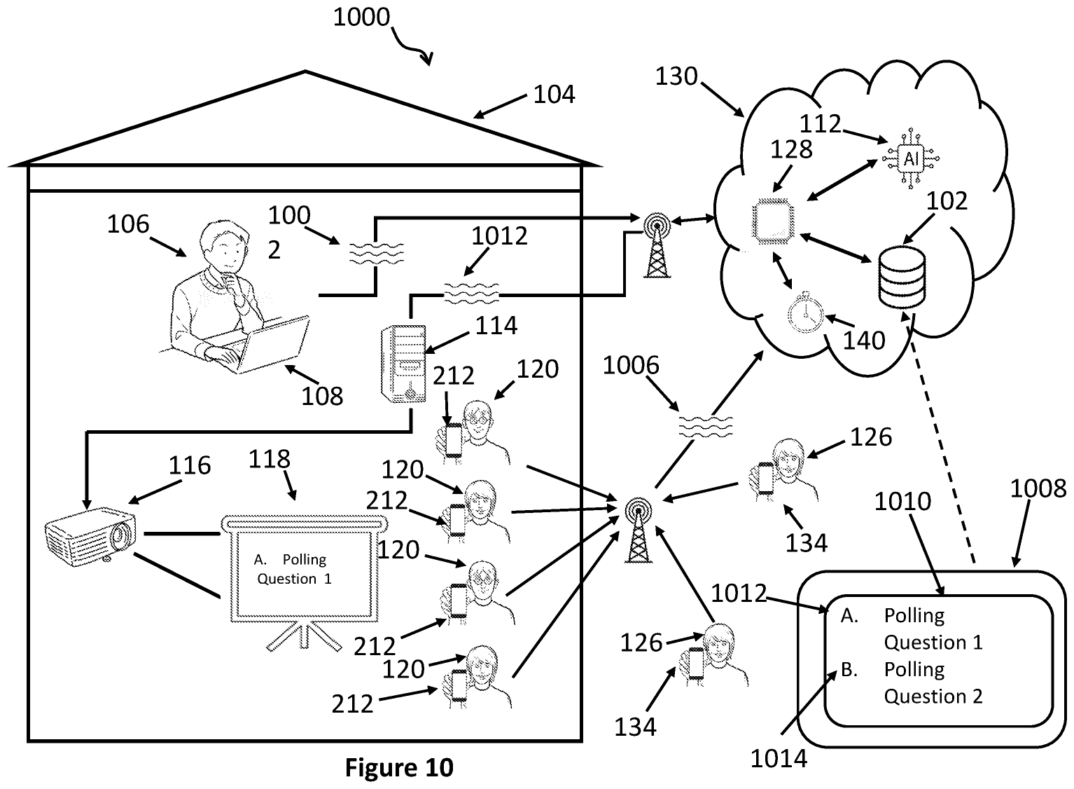

FIG. 10 shows an exemplary classroom enrollment data file 1302 which includes distinct data storage location for each student 120, 126 who are scheduled to be in classroom 104. The data stored in the data storage for each student 120, 124 may include data for identifying students 120, 126. The information for identifying student 120, 126 may include student 120, 126 identification data and a distinct mobile device identifier matched with the students 120, 126.

Relational database 102 may store one or more instructional modules 220 (i.e., attendance module, learning module, brainstorming module, polling module) for use in controlling the operation of cloud-based processor 128. Icons may be displayed on first computer screen 200 which corresponds to the module to which it refers. For example, an attendance module icon may communicate data corresponding to the attendance module (referred to attendance module 204) stored in relational database 102. When the attendance module icon is selected, for example by the teacher 106, first computer 108 data communicates a signal to cloud based processor 128 to access attendance module 204 stored in relational data base 102. Selecting learning module icon 206 may cause first computer 108 to communicate data corresponding to the learning module (referred to learning module 206) stored in relational database 102 to cloud-based processor 128 for accessing learning module 206 stored in relational database 102. Selecting brainstorming module icon may cause first computer 108 to communicate data corresponding to the brainstorming module (referred to brainstorming module 208) stored in relational database 102. Selecting polling module icon 210 may cause first computer 108 to communicate data corresponding to the polling module (referred to polling module 210) stored in relational database 102. When “icon” is used, it refers to the representations displayed on first computer screen 200 which may be used to represent the modules stored in relational database 102. Icons as used herein may be pictorial representations, alphanumeric representations, graphical representations, or the like.

As used herein, an icon may be any graphical or alphanumeric object that represents any one of the modules described herein. Icons may include pictorial, image, token, symbol or the like. Icons are any object that may be displayed on and selected from first computer screen 200.

Teacher 106 may select one of the icons 202 using any conventional means for selecting icons on a first computer screen 200. When teacher 106 selects the icon corresponding to attendance module 204, first computer 108 sends instructions to cloud-based processor 128 to activate attendance module 204. Attendance module 204 may include a computer program when accessed by cloud-based processor 128 performs tasks for taking the attendance of students 120 inside classroom 104. Teacher 106 may use a conventional computer, such as a first computer 108, to generate a take attendance check signal 110 (step 302) and provided attendance check signal 110 to cloud-based processor 112 (step 304). In one embodiment, first computer 108 may generate a random attendance check signal for providing to cloud-based processor 112.

Teacher 106 may use first computer 108 to select attendance module icon 204 to send a signal (i.e., “take attendance signal 110”) to cloud-based processor 128 (Step 302). Cloud-based processor 128 may receive take attendance signal 110 and retrieve instructions from relational database 102 to check attendance of the plurality of student 120 that are in classroom 104. Cloud-based processor 128 may send a confirm attendance signal to artificial intelligence engine 112 for generating a random check attendance code 132. Artificial intelligence engine 112 may provide the random check attendance code 132 to cloud-based processor 128. Cloud-based processor 128 may provide the random check attendance code 132 to second computing system 114 (Step 306).

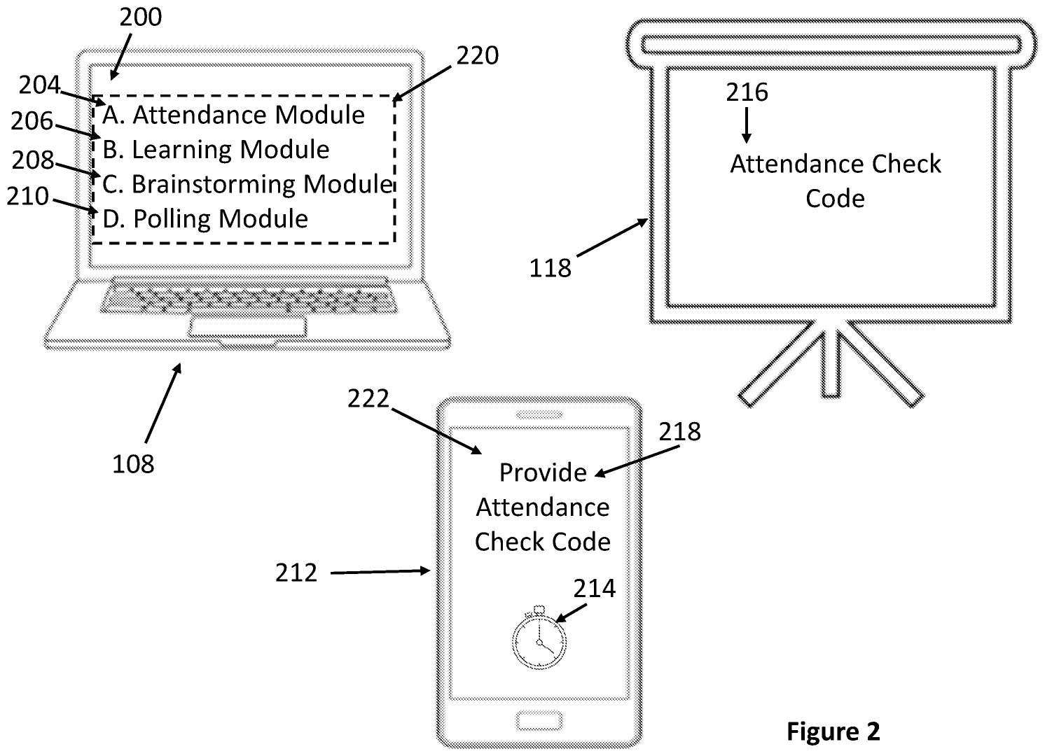

Second computing system 114 may receive random attendance check code 132 from cloud-based processor 128 and further provide the check attendance code 132 to projector 116. As shown in FIG. 2, projector 116 may further provide the random attendance check attendance code 132 to be displayed on projector screen 118. In one embodiment, each one of the mobile devices 212 may further receive a prompt from cloud-based processor 128 requesting each one of the plurality of students 120 to individually provide a responding check attendance code 122 to cloud-based processor 128. Students 120 may use mobile device 212 to send the responding check attendance code 122 to cloud-based processor 128. The prompt may be displayed on mobile device screen 222.

A timer 214 may be displayed on the mobile device screen 222 of each one of the mobile devices 212. The timer 214 may indicate the time allotted for students 120 to send a responding check attendance code 122 to cloud-based processor 128. Timer 214 may display the same time as timer 140. In exemplary embodiment, timer 214 may count down from a predetermined time to a time equal to zero. The timer 214 will start counting as soon as the random check computer code 132 is displayed on projector screen 118. Once timer 214 reaches zero, (or a time predetermined time allotted for responding to the activity) then the time send a responding check attendance code 122 to cloud-based processor 128 has expired. Responding check attendance code 122 may include the time stamp indicating the time student 120 sent a response to the prompt displayed on mobile device screen 222.

Cloud-based processor 128 may receive the responding check attendance code 122 (Step 310) and determine if the responding check attendance code 122 time stamp indicates the mobile device 212 sent the responding check attendance code 122 after timer 114 has expired (314). If the timer has expired, cloud-based processor 128 may determine if the student 126 has provided an excuse absence code to teacher 106 (Step 320). Cloud-based processor 128 may also compare the responding check attendance code 122 to attendance check code 132 (Step 314) to see if the codes match. Cloud based processor 128 may store the results of the matching operation in relational database 102 (Step 318). If responding check attendance code 132 does match check attendance code 122, then cloud-based processor 128 may determine if student 126 provided an excuse absence notice to teacher 106 (Step 320).

Relational database 102 may include a distinct storage area corresponding to each one of the students 120 inside classroom 104 and distinct storage area corresponding to each one of the students 126 not inside classroom 104. The distinct storage area corresponding to each one of the students 120, 126 may include data pertaining each one of the students 126 attendance records, classroom performance, tutoring schedule, tutoring plan, responses to quizzes or tests related to prepared learning objectives, responses to brainstorming questions, and polling questions. Cloud-based processor 128 may be configured to send data for updating the distinct data storage area with data received from mobile devices 134, 212, as described more fully below.

In one exemplary embodiment, one of the students 126 may not be located in classroom 104 when timer 214 is counted down to a zero value (e.g., timer 214 is expired). Student 126 not present in classroom 104 may provide an excused absence notice to teacher 106 indicating that the student 126 will not be present in classroom 104 (an “excused absence”) when timer 214 counts down to zero time.

An excused absence occurs when the student has informed teacher 106 that he will not be present in the classroom when check attendance code 132 is displayed on projector screen 118. Teacher 106 may store data pertaining to the excused absence notice in the distinct data storage area corresponding to the student 126 in relational database 120. For example, once teacher 106 receives an excused absence notice from a student 126, teacher 106 may send data pertaining to the excused absence notice to cloud-based processor 128. Cloud-based processor 128 may then store the data pertaining to the excused absence notice in relational database 102 in the storage area correlated to student 126. Cloud-based processor 128 may store the excused absence notice data in the storage area corresponding to the student 126 that provided the excused absence notice to teacher 106.

In another exemplary embodiment, student 126 outside the classroom may send a message explaining why they will be absent at a future date using their mobile phones 134 which is received by cloud processor 130. Cloud-processor 130 may provide the explanation to AI engine 112 for interpreting the message and automatically stores the message as an excused absence in the distinct data storage area corresponding to the student 126 as described above. The student 124 may provide the explanation in natural language. By “interpreting” what may be meant is that the AI engine may receive the explanation from student 126 mobile phone 134 and evaluate it to determine if the explanation meets requirements established for an acceptable excused absence.

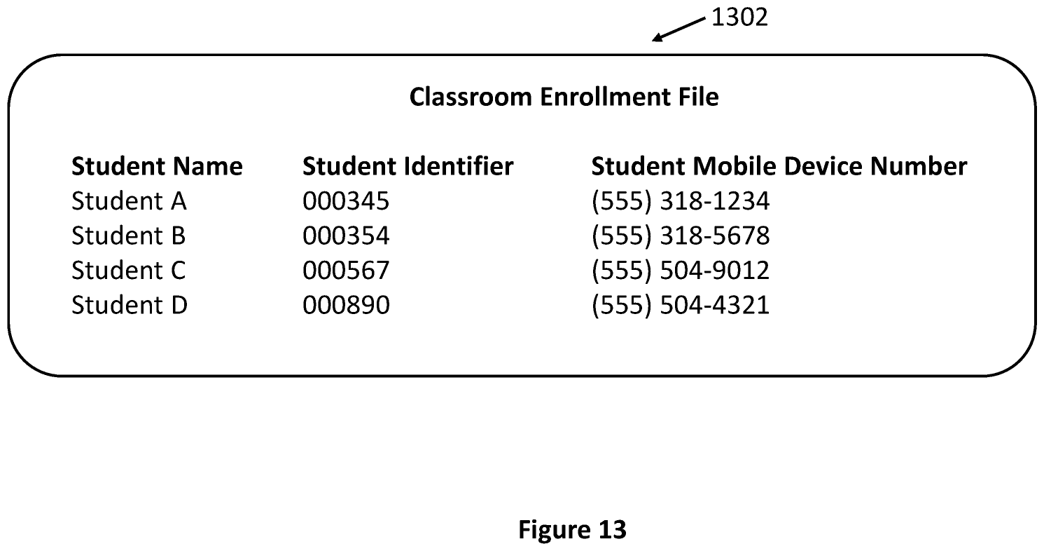

In another embodiment of the invention, cloud-based processor 128 may receive a plurality of responding check attendance codes 122 wherein each of the plurality of responding check attendance codes 122 is provided by distinct mobile devices 134, 212. Cloud-based processor 128 may compare the classroom enrollment file 1302, shown in FIG. 13, to the received responding check attendance codes 122 received to see if all students 120, 126 have sent a responding check attendance code 122. If any one of the plurality of students 120, 126 fails to send a responding check attendance code 122, then cloud-based processor 128 determines that one of the students 120, 126 has failed to provide a matching responding check attendance code 122 (Step 316), then cloud-based processor 128 may further determine whether students 120, 126 that has failed to provide a matching responding check attendance check code 122 has provided an excused absence notice to teacher 106 (Step 320). Cloud-based processor 128 may record an unexcused absence in the distinct storage area corresponding to the absent student 120, 126 (Step 328). By “absent” what is meant is that the student is not physically located in the classroom. By “unexcused absence” what is meant is that the student is absent from the classroom, and the student has not given a excused absence notice to teacher 106, of provided an excused absence message to AI engine 112.

If any one of the plurality of students 120, 126 has failed to provide a matching responding check attendance code 122 (Step 320) then cloud-based processor 128 may receive a personalized tutoring plan from AI engine 112 (Step 322) where the tutoring plan is personalized to the student 120, 126 that has failed to provide a matching responding check attendance code 122. In one exemplary embodiment, the cloud-based processor 128 may retrieve from the relational database 102 data corresponding to the one of the plurality of students 120, 126 and provide the data retrieved from relational database 102 to AI engine 112 for use in preparing a personalized tutoring plan. AI engine 112 may use the data received from relational database 102 to prepare the personalized tutoring plan. The personalized tutoring plan may include information on what is being taught in classroom 104 on the day the student 120, 126 failed to provide a matching responding check attendance code 122. The data received from relational database 102 may include, for example, the student's prior test or quiz results, or information related to the preferred language in which the student prefers to communicate, the student's areas of learning weakness, and the student's attendance record. Cloud-based processor 128 may retrieve the data from relational database 102 and provide the data to AI engine 112. AI engine 112 may receive the data from cloud-based processor 128 and prepare a personalized tutoring plan. The personalized tutoring plan may include a personalized pedagogy for the student 120, 126, where the pedagogy includes one or more teaching techniques, such as, scaffolding, differentiation, expeditionary learning, game-based learning or inquiry-based learning. The personalized tutoring plan may include interactive learning, wherein the student may communicate in real-time with cloud-based processor 128 or AI engine 112. The student may communicate in real-time with cloud-based processor 128 using conversational communication technology wherein the AI engine communicates with student 120, 126 using natural language.

AI engine 112 may provide the personalized tutoring plan to cloud-based processor 128 (Step 322). Cloud-based processor 128 may further provide the personalized tutoring plan to mobile device 134, 212 (Step 324). Mobile device 134, 212 may include various communication interfaces permitting student 120, 126 to interact with AI engine 122 (Step 326). For example, mobile device 134, 212 may include a conventional text interface, or voice to text interface permitting the student to communicate with AI engine 112 through speech. In one exemplary embodiment, cloud-based processor 128 may record the results of the student 120, 126 communications with AI engine 112.

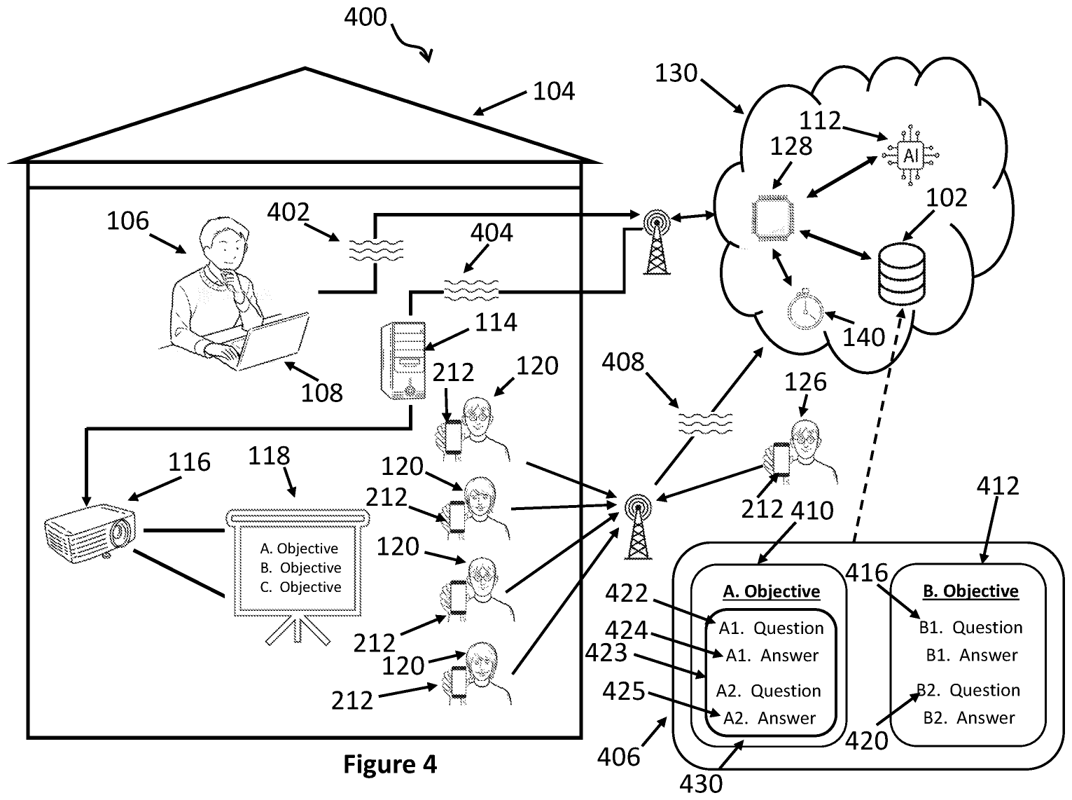

In another exemplary embodiment of the present invention shown in FIG. 4, a computer-based ITS 400 may be configured to provide quiz questions, 416, 420, 422, 423 to students 120, 126 and to receive real-time responses to the quiz questions. System components shown in ITS 400 operate and communicate similarly to the same or similar elements as is described in ITS 100. For example, teacher 106 may select the learning module icon 206 included in the list of instructional modules 220 displayed on first computer screen 200. Teacher 106 may select the learning module 206 in much the same way as was described above with respect to attendance module 204. When teacher 106 selects learning module icon 206, first computer 108 may send a signal to cloud-based processor 128 to access a learning objective datafile 406 stored in relational database 102.

Teaching objectives data file 406 may include teaching objectives 410, 412. Each one of the teaching objectives 422, 423 may include teaching objective questions (A. Objective 422, B. Objective 423). During operation, teaching objective question icons 422, 423 may be displayed on first computer screen 200. Teacher 106 may select at least one of teaching objective question icons 422, 423 to send an instruction to cloud-based processor 128 to provide the selected teaching objective questions 422, 423 to students 120, 126.

Teacher 106 may send teaching objections data file 406 to relational database 102 to be stored for later access and retrieval (Step 602). Teacher 106 may store teaching objectives data file 406 in relational database 102 using any conventional method as is known for storing data in a cloud-based database.

Teaching objectives data file 406 may include a plurality of distinct teaching objectives 410, 412 to be presented to the plurality of students 120. Each one of the plurality of teaching objectives 410, 412 may further include quiz questions 422, 423. Quiz questions 422, 423 may be presented to the plurality of students 120, 126 to determine whether students 120, 126 are comprehending the teaching objectives 410, 412. Each of the quiz questions 422, 423 may be paired with corresponding quiz answers 424, 425, respectively. For example, quiz question 422 (A1. Question) is paired with quiz answer 423 (A1. Answer). Students 120, 26 may provide quiz answer 424 in response to quiz question 422 to indicate students 120, 126 understands the learning objective 422 (A. Objective). It should be noted that in one exemplary embodiment, quiz questions 422 may be provided to students 126 outside the classroom but who are participating online. In still another embodiment, students 126 having an unexcused absence may not be provided quiz questions 422.

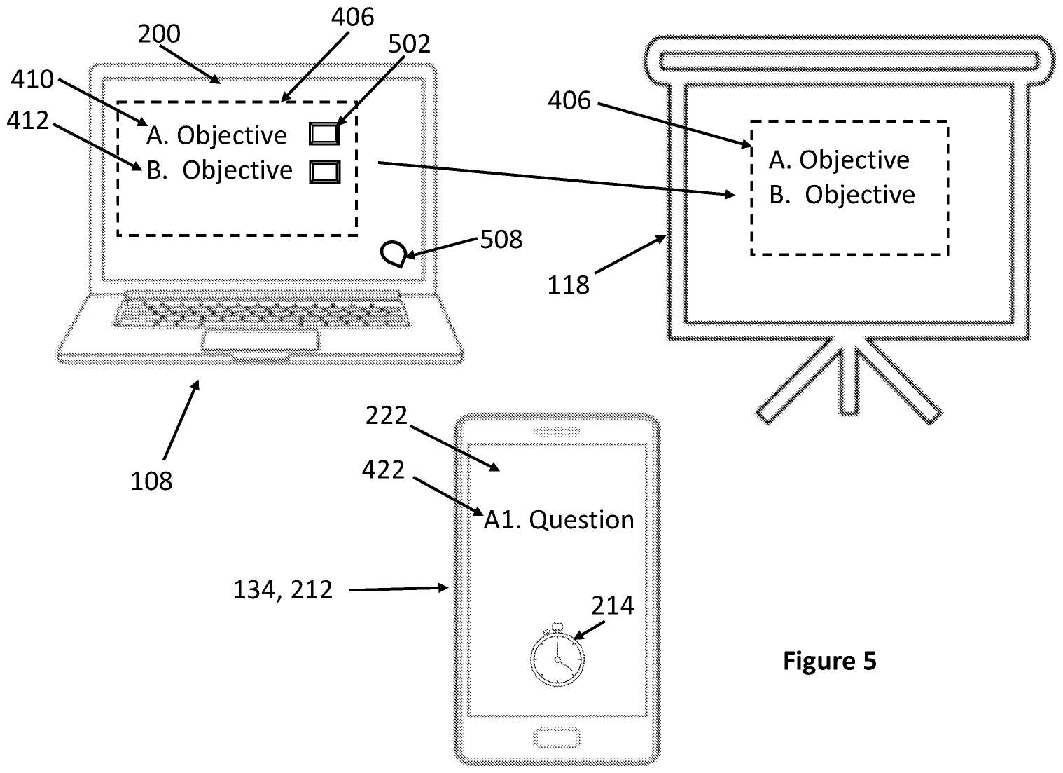

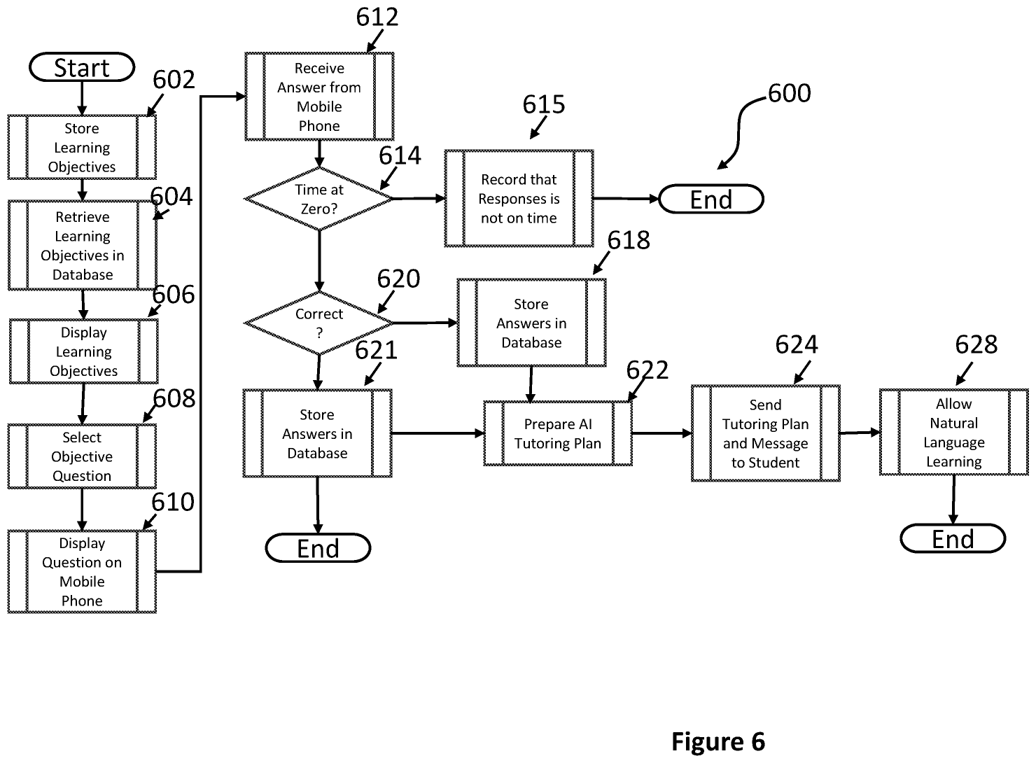

FIGS. 4-6 show ITS 400 in operation. Teacher 106 may select the learning modules icon 206 displayed on first computer screen 200. In response to teacher 106 selecting learning module 206, first computer 108 may send data (e.g., “prepare learning objectives signal 402) to cloud-based processor 128 to initiate student 120 learning. Cloud-based processor 128 may receive the prepare learning objectives signal 402 and retrieve the learning objective data file 406 from relational database 102 (Step 604). Cloud-based processor 128 may provide the learning objective data file 406 to first computer 108 to be displayed on first computer screen 200 (Step 606).

Cloud-based processor 128 may provide learning objectives 410, 412 to second computer 114. Second computer 114 may further provide the learning objectives 410, 412 to projector 116. Projector 116 may then provide learning objectives 410, 412 to projector screen 118 to be seen by students 120.

When teacher 106 wants to test students 120 comprehension of learning objectives 410, 412, teacher 106 may activate a quiz taking exercise by, for example, selecting a take quiz icon associated with at least one of the objectives 410, 412 (Step 608). For example, first computer screen 200 may display learning objective 410 linked to a quiz question icon 502. Teacher 106 may select the quiz question icon 502. Once teacher 106 selects take quiz icon 502, first computer 108 may send a signal to cloud-based processor 128 to retrieve quiz question 422 related to learning objective 410 stored in relational database 102. Cloud-based processor 128 may then provide the quiz question 422 to student mobile device 212 to be displayed on mobile device screen 222 (Step 610). Students 120 may see quiz question 422 and use mobile device 212 to provide a quiz question response 408 to cloud-based processor 128.

In embodiment, cloud-based processor 128 may receive a signal from first computer 108 and provide a signal to AI engine 112. AI engine 112 may receive the signal from cloud-based processor 128 and a prepare personalized quiz to be provided to student mobile device 212. By “personalized” what is meant is that AI engine 112 prepares the personalized quiz using data stored in relational database 102 that is associated with student mobile device 212. For example, where a mobile device 212 is associated with a mobile phone 212 identifier, then AI engine 112 prepares a personalized quiz using data stored in relational database 102 which is associated with the mobile phone 212 identifier.

In similar manner as is discussed above, timer 214 may be displayed on the mobile device screen 222 of each one of the mobile devices 212. Timer 214 may indicate the time allotted for students 120 to provide a quiz question response 408 to cloud-based processor 128. Timer 214 may display the same time as timer 140. In exemplary embodiment, timer 214 may count down from a predetermined time to a time equal to zero. Quiz response 408 may include a time stamp indicating at what time student 120 sent the quiz question response to cloud-based processor 128.

Upon receiving quiz response 408 (Step 612), cloud-based processor 128 may compare the quiz response 408 time stamp to the time value on timer 114. If timer 114 has expired, then cloud-based processor 128 may record in relational database that quiz response 408 did not arrive on time (Step 615). Cloud-based processor 128 may then prepare a tutoring plan to the students 120 that did not send their quiz responses 408 on time (Step 612). If after comparing the quiz response 408 time stamp indicates that the response arrived on time (e.g., timer 114 is not expired), then cloud-based processor 128 may store the on time quiz response 408 in relational database 108 (Step 621). Cloud-based processor 128 may store the quiz response 408 in the storage space assigned to the student 120 that has submitted the response.

The result of the comparisons made herein may be stored in relational database 102 in the distinct storage area corresponding to the students 120 providing the student response to cloud-based processor 128 for comparison (Step 618). If after comparing the student quiz response 408, cloud-based processor 128 determines that the student response does not match the quiz answer 418, then cloud-based processor 128 may send a data signal to AI engine 112 to prepare a personalized tutoring plan as described above (Step 622). Cloud-based processor 128 may receive the personalized tutoring plan from AI engine 112 and provide the personalized tutoring plan to the student 120 (Step 624). For example, cloud-based processor 128 may send the tutoring plan to student mobile device 212 using the 10 DLC system. Student 120 may use student mobile device 212 to engage in interactive tutoring as described above (Step 628). In one exemplary embodiment, student 120 may engage in a interactive tutoring with AI engine 112 using natural language communication. The invention contemplates changing from text to voice when the content of the subject matter requires voice-based delivery.

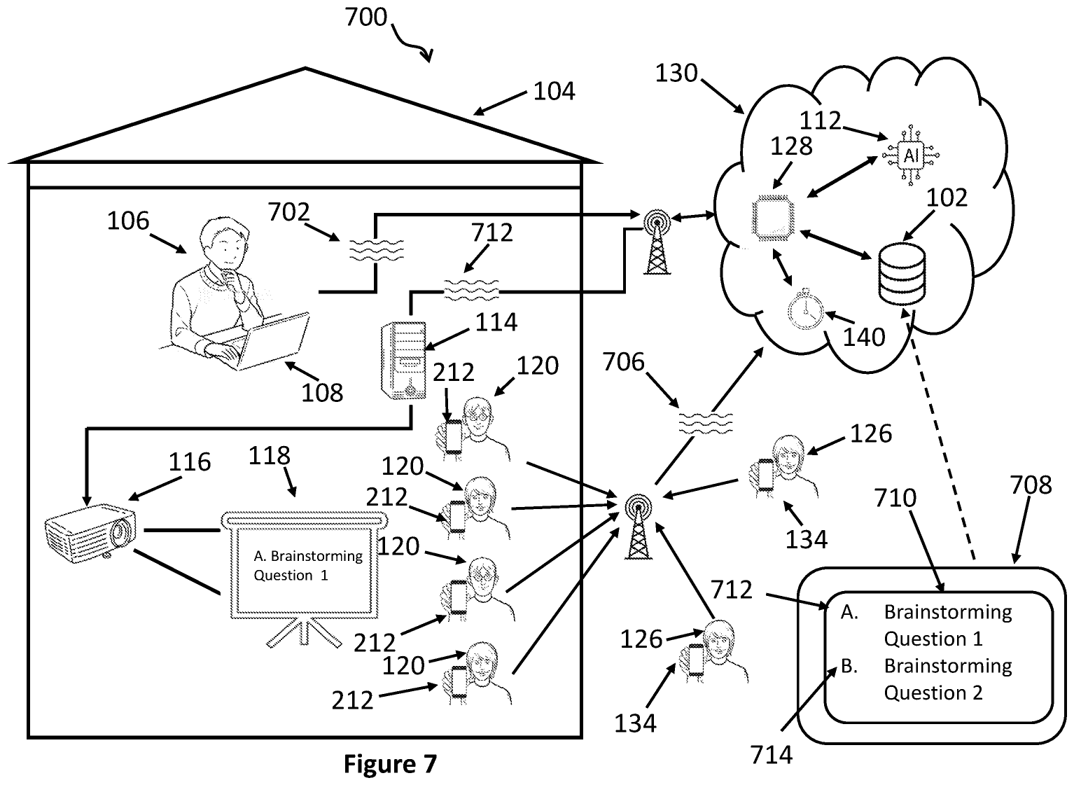

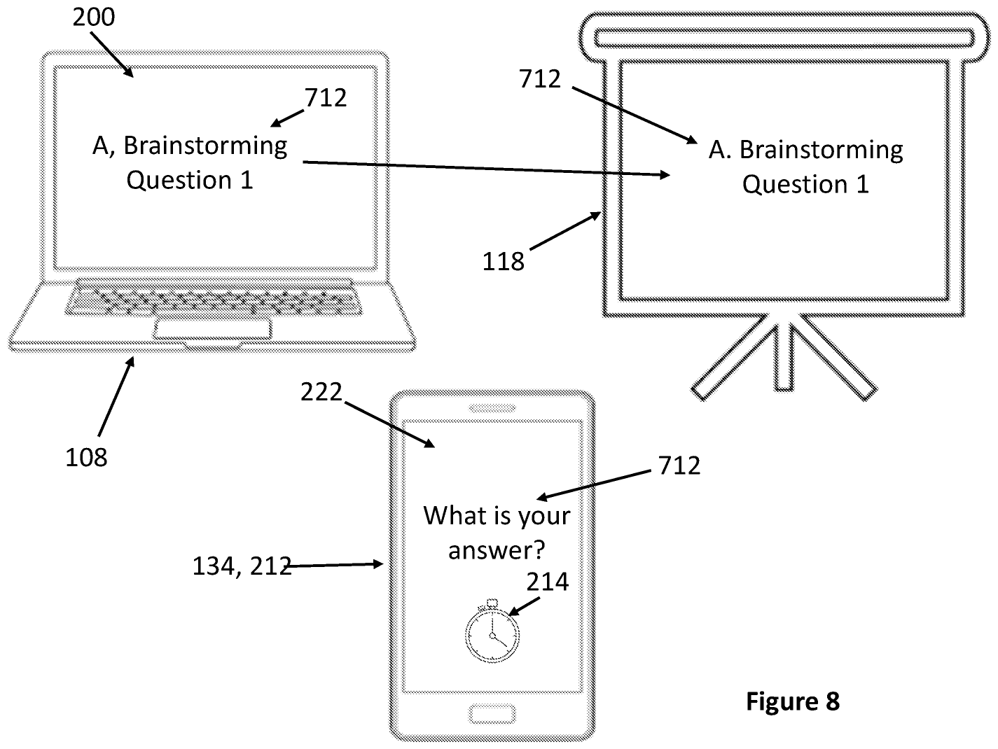

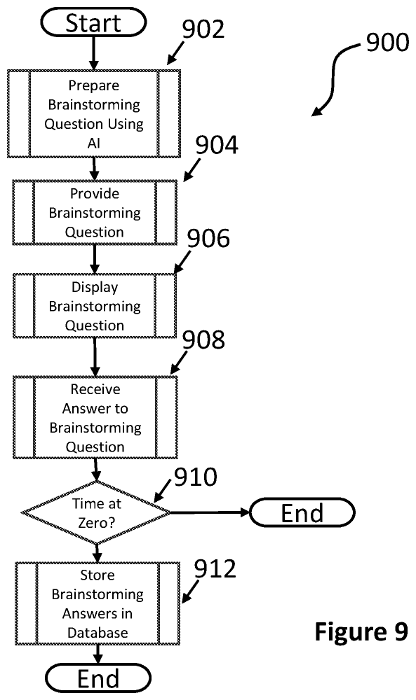

FIGS. 7-9 depict another exemplary embodiment of a computer-based ITS 700 configured to provide brainstorming questions to the plurality of students 120, 126 in real-time, and to receive real-time responses to select brainstorming questions. (e.g, A. Brainstorming Question 1 712). System components shown in ITS 700 operate and communicate similarly to the same or similar elements as is described in ITS 100, 400. For example, with brief reference to FIG. 2, teacher 106 may select brainstorming module icon 206 included in the list of instructional modules 220 displayed on first computer screen 200. Teacher 106 may select brainstorming module 206 in much the same way as was described above with respect attendance module 204.

Teacher 106 may prepare a brainstorming data file 708 to be stored in relational database 102 (Step 902). Brainstorming data file 708 may contain a datafile of brainstorming questions data file 710. Brainstorming questions data file 710 may include one or more distinct brainstorming questions 712 (A. Brainstorming Question 1), 714 (B. Brainstorming Question 2).

Teacher 106 may store brainstorming datafile 708 in relational database 102 for later access and retrieval by cloud-based processor 128 using conventional methods for storing datafiles in a cloud-based processor. During operation, teacher 106 may select brainstorming module 208 displayed on first computer screen 200. Once teacher 106 selects brainstorming module 208, first computer 108 may send a signal to cloud-based processor 128 to retrieve brainstorming questions data file 710 from relational database 102. Cloud-based processor 128 may then provide brainstorming questions datafile 710 (including brainstorming questions 712, 714) to first computer 108 to be displayed on first computer screen 200 (Step 904).

Teacher 106 may select at least one of the plurality of brainstorming questions 712, 714 to be displayed on student mobile devices 134, 212. Once teacher 106 selects the at least one brainstorming question 712, 714, first computer 108 sends a signal to cloud-based processor 128 to instruct cloud-based processor 128 to send the selected one of the brainstorming questions 712, 714 to second computer 114 (Step 904). Second computer 114 may further provide the selected brainstorming question 712, 714 to projector 116. Projector 116 may provide the select brainstorming question 712, 714 to projector screen 118 to be displayed on projector screen 118 (Step 906). Students 120, 126 may view brainstorming question 712, 714 displayed on the projector screen 118 and use mobile device 212, 134 to provide a brainstorming question response 706 to cloud-based processor 128. In one exemplary embodiment, students who have not provided an excused absence may not be provided the brainstorming question 712, 714 or permitted to provide a response.

In another embodiment of the invention, one or more students 126 may be located outside of classroom 104. In such embodiment, cloud-based processor 128 may retrieve the selected brainstorming question 712, 714 from relational database 102 and provide the selected brainstorming question 712, 714 to student mobile device 134. The provided brainstorming question 712, 714 may be displayed on mobile device screen 222. A student 126 that is outside the classroom 104 may view the select brainstorming question 712 on mobile device 134 screen. Student 126 may then provide a brainstorming question response 706 to cloud-based processor 128.

Cloud-based processor 128 may receive brainstorming question response 706 (Step 908) and provide the response to relational database 102 for storage. Cloud-based processor 128 may further provide the brainstorming question response 706 to first computer 108. First computer 108 may display brainstorming question response 706 on first computer screen 200.

In another exemplary embodiment, cloud-based processor 128 may provide the plurality of brainstorming question responses to AI engine 112. AI engine 112 may receive the plurality of brainstorming questions 706 and analyze, process, consolidate, the brainstorming questions 706. AI engine 112 may further provide the processed brainstorming question responses to cloud-based processor 128. The cloud-based processor 128 may provide the processed brainstorming question responses to first computer 108 to be displayed on computing device first computer screen 200.

In similar manner as is discussed above, timer 214 may be displayed on the mobile device screen 222 of each one of the mobile devices 212, and on projector screen 118. Timer 214 may indicate the time allotted for students 120, 126 to provide a brainstorming question response 706 to cloud-based processor 128. Timer 214 may display the same time as timer 140. In exemplary embodiment, timer 214 may count down from a predetermined time to a time equal to zero. Once timer 214 reaches zero, then the brainstorming question response 706 may be considered not on time. Brainstorming question response 706 may include a time stamp indicating the time when student 120 sent the brainstorming question response to cloud-based processor 128.

Cloud-based processor 128 may receive the brainstorming question response 706 and compare the brainstorming question response 706 time stamp with timer 214 (Step 910). If the brainstorming question considered not on time, cloud-based processor 128 may end the brainstorming process. Otherwise, if after comparing the brainstorming question response 706 time stamp, cloud-based processor 128 may store the brainstorming response 706 in relational database 102 (Step 912). Where a plurality of brainstorming responses 706 are received, the plurality of brainstorming response 706 may be displayed on the projector screen 118 one after another to the to show all the brainstorming responses 706 received from students, whether the students are inside the classroom 104 or online in a hybrid classroom environment. These responses 706 may then be discussed in classroom 104 by teacher 106 for learning purposes on a topic. Since the brainstorming responses 706 may be stored before they are displayed, brainstorming responses 706 may be sorted in order of relevance, highlighted, or deleted to facilitate the discussion from the brainstorming responses.

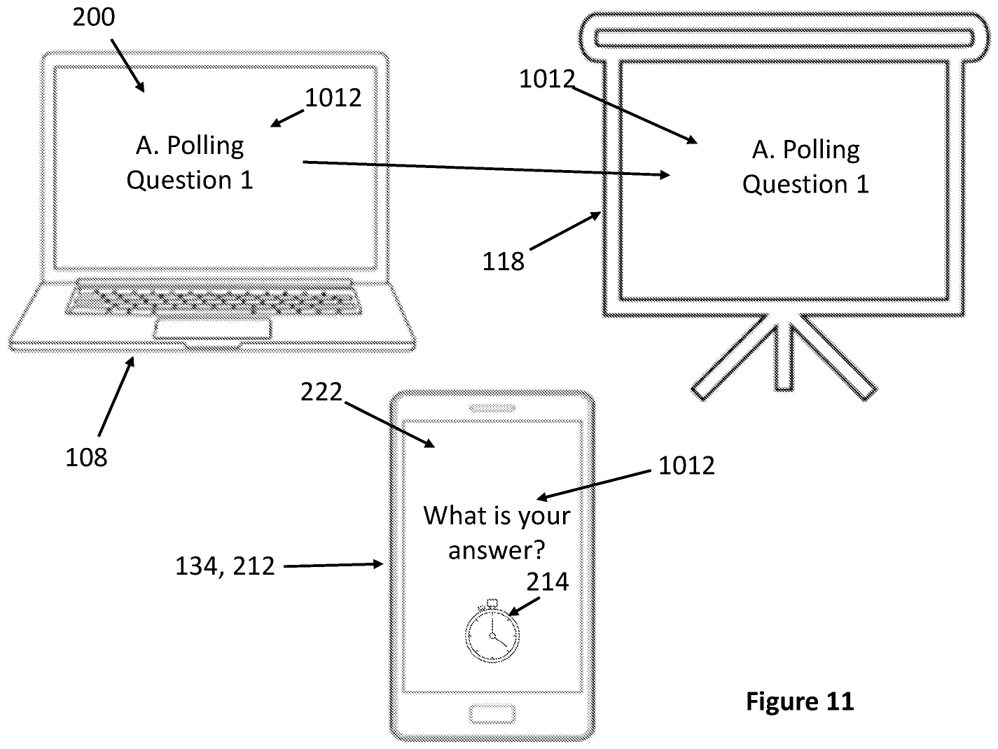

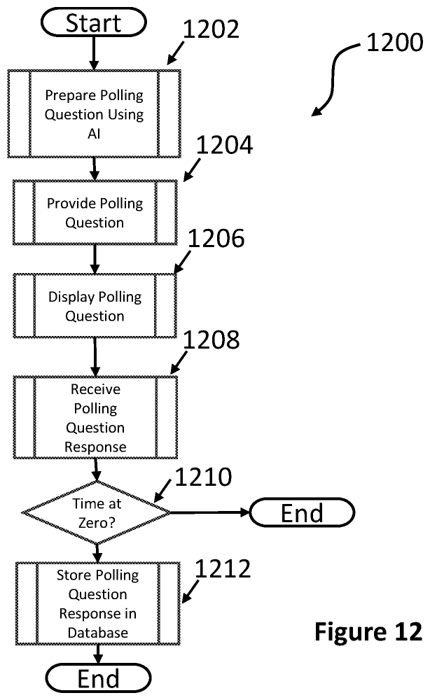

In another embodiment shown in FIGS. 10-12, ITS 1000 may be configured to provide polling questions (e.g., A. Polling Question 1 1012, B. Polling Question 2 1014) to students 120, 126. Teacher 106 may prepare a polling question data file 1008 containing a datafile of a plurality of polling questions 1010 (Step 1202). Polling questions data file 1010 may include one or more distinct polling questions 1012 (A. Polling Question 1), 1014 (B. Polling Question 2) from which teacher 106 may select for providing to student mobile device 212, 134 as described more fully below. Teacher 106 may store polling questions datafile 1008 in relational database 102 for later access and retrieval by cloud-based processor 128 using conventional methods for storing and retrieving datafiles in a relational database 102.

During operation, teacher 106 may select polling questions module icon 210 displayed on first computer screen 200. Once teacher 106 selects polling question module icon 210, first computer 108 may send a signal to cloud-based processor 128 to retrieve polling questions data file 1008 from relational database 102. The content of polling questions datafile 1008 (e.g., polling questions 1012, 1014) may then be displayed on the first computer screen 200. Teacher 106 may further select at least one of the plurality of polling questions 1012, 1014 to be provided to students 120, 126.

Once teacher 106 selects the at least one of polling questions 1012, 1014, first computer 108 may send a signal to cloud-based processor 128 to provide the selected one of polling questions 1012, 1014.

Cloud-based processor 128 may receive polling question module signal 1002 and retrieve the selected polling question 1012, 1014 from relational database 102. Cloud-based processor 128 may provide the selected polling question 1012, 1014 to second computer 114 (Step 1204). Second computer 114 may further provide the selected polling question 1012, 1014 to classroom projector 116. Classroom projector 116 may provide the select polling question 1012, 1014 to projector screen 118 to be displayed and perceived by students 120 (Step 1204). Students 120 may view polling question 1012 displayed on the projector screen 118. Students 120 may use mobile device 212 to provide the polling question response 1006 to cloud-based processor 128.

In another embodiment of the invention, one or more students 134 may be located outside of classroom 104. In such an embodiment, cloud-based processor 128 may retrieve the selected polling question 1012, 1014 from relational database 102 and provide the selected polling question 1012, 1014 to student mobile device 134 located outside classroom 104 (Step 1204). The polling question 1012, 1014 may be displayed on mobile device 134 display screen. Student 134 that is outside the classroom 104 may view the selected polling question 1012, 1014 and provide a polling question response 1006 to cloud-based processor 128. Cloud-based processor 128 may receive polling question response 1006 for processing.

In similar manner as is discussed above, timer 214 may be displayed on the mobile device screen 222 of each one of the mobile devices 134, 212. Timer 214 may indicate the time allotted for students 120, 126 to provide polling question response 1006 to cloud-based processor 128. Timer 214 may display the same time as timer 140. In exemplary embodiment, timer 214 may count down from a predetermined time to a time equal to zero. Polling question response 1006 received after timer 214 reached zero (e.g., timer 214 is expired) is considered untimely. Polling question response 1006 may include a time stamp indicating at what time student 120 sent the brainstorming question response 1006 to cloud-based processor 128.

Cloud-based processor 128 may receive polling question response 1006 and provide the polling response 1006 to relational database 102 for storage. Cloud-based processor 128 may further provide the polling question response 1006 to first computer 108. First computer 108 may display polling question response 1006 on first computer screen 200.

In another exemplary embodiment of the invention, a plurality of students 120, 126 may send a plurality of polling question responses 1006 to cloud-based processor 128. Cloud-based processor 128 may receive the plurality of polling question responses 1006 and provide the polling question responses to first computer 108 to be displayed on first computer screen 222.

In another exemplary embodiment, cloud-based processor 128 may provide the plurality of polling question responses 1006 to AI engine 112. AI engine 112 may receive the plurality of poling questions 1006 and analyze, process, consolidate, the polling questions responses 1006. AI engine 112 may provide the processed polling question responses 1006 to cloud-based processor 128. The cloud-based processor 128 may provide the processed polling question responses to first computer 108 to be displayed on first computer screen 200. Additionally, cloud-based processor 128 may provide the processed poll question responses to relational database 102 for storage.

It should be noted that although the invention discusses tutoring plans being provided to students 120 inside the classroom 104, the invention contemplates sending tutoring plans to students in hybrid classrooms including online students. Tutoring plans may be prepared for any student whose scholastic performance indicates that the student does not understand the subject matter or objective presented. Tutoring plans may be prepared based on real-time results of in class activities.

Further still, while the invention discusses quizzes and quiz questions, it should be understood that the invention contemplates providing students with tests. Such test may require the student to provide sentences, paragraphs and or short answers, or the like, in response to the questions provided. In such instances, AI engine 112 may be configured to evaluate the responses for correctness in much the same way that discrete responses are evaluated above. The student response may be stored in the relational database for use in preparing personalized tutoring plans.

Additionally, while the invention discusses retrieving polling questions from a polling module, the invention contemplates providing polling questions to the students that have been typed into first computer 200.

In yet another embodiment, the brainstorming responses, quiz responses, test responses, polling question responses, may be displayed on projector screen 118 to facilitate classroom discussion. With respect to brainstorming, the received responses may not be stored. However, AI engine 112 or cloud-based processor may tract which students have submitted a response to keep a record of which students have participated in the classroom exercise.

In still another embodiment of the invention, the data stored in relational database 102 may include data associated with a plurality of classrooms 104. In such an instance, the invention contemplates aggregating the data from the plurality of classrooms 104 into a single combined classroom data file. The combined classroom data file may be provided to an AI engine for processing. In another exemplary embodiment, each of the data associated with the plurality of classrooms 104 may be provided to an AI engine for processing individually and then collectively. By “processing” here, what is meant may be that the AI engine analyzes, manipulates, organizes, or combines the data, or the like.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claim(s) and their legal equivalents.

What is claimed is:

1. A system for taking classroom attendance of a plurality of students located inside a classroom, comprising:
a. a first classroom computer for generating a take attendance signal, wherein the first classroom computer is located inside a classroom;
b. a cloud-based processor for receiving the take attendance signal, the cloud-based processor generating a confirm attendance code in response to the take attendance signal;
c. a cloud-based artificial intelligence (AI) engine for receiving the confirm attendance code, wherein the cloud-based artificial intelligence engine generates an attendance check code in response to receiving the confirm attendance code;
d. a second classroom computer for receiving the attendance check code, wherein the second classroom computer provides the attendance check code;
e. a projector for receiving the attendance check code and displaying the attendance check code to be visually seen by a plurality of students in the classroom;
f. a timer for counting down time from a predetermined time to zero time when the attendance check code is displayed;
g. A plurality of mobile devices for providing a distinct plurality of responding attendance check codes to the cloud-based processor before the timer is at zero time, wherein each one of the plurality of mobile devices provides the distinct one of the plurality of attendance check codes to the cloud-based processor, wherein at least one of the plurality of mobile devices is being activated by a distinct one of the plurality of students in the classroom to send the distinct one of the plurality of responding attendance check codes, wherein the cloud-based processor compares the distinct one of the plurality of responding attendance check codes to the attendance check code to produce a comparison result; and
h. A cloud-based relational database for receiving the comparison result and storing the comparison result in the cloud-based relational database, wherein the cloud-based relational database includes at least one storage area corresponding to the each one of the plurality of students in the classroom, wherein storing the comparison result includes storing the comparison result in a distinct storage area of the cloud-based relational database corresponding to at least one of the plurality of students in the classroom.

2. A system according to claim 1, wherein the comparison result includes data indicating that at least one of the plurality of students is not in the classroom when comparison result indicates that the distinct one of the plurality of responding attendance codes does not match the attendance check code.

3. A system according to claim 2, wherein the cloud-based AI engine generates a student absent notice and a personalized tutoring plan for the at least one of the plurality of students based on the comparison result.

4. A system according to claim 3, wherein the cloud-based AI engine provides the student absent notice and tutoring plan to the at least one of the plurality of mobile device.

5. A system according to claim 4, wherein the cloud-based AI engine receives natural language communication using webhooking from the at least one of the mobile devices to facilitate a tutoring session.

6. A system according to claim 5, wherein the cloud-based AI engine generates a random attendance check code.

7. A system according to claim 2, wherein the at least one of the plurality of mobile devices generates a student excused code, and wherein the cloud-based processor receives the student excused code from at least one of the plurality of mobile devices.

8. A system according to claim 7, wherein the cloud-based processor provides the student excused code to the cloud-based relational database, wherein the cloud-based-relational database stores the student excused code in the at least one storage area corresponding to the at least one of the plurality of mobile devices.

9. A system according to claim 8, wherein the cloud-based AI engine generates a personalized tutoring plan, wherein the tutoring plan is personalized for the at least one mobile devices that provided the student excused code.

10. A system according to claim 9, wherein the cloud-based AI engine provides the student absent notice and tutoring plan to the at least one of the plurality of mobile device that provided the student excused code.

11. A system according to claim 10, wherein the at least one of the plurality of mobile device provides a natural language communication to the cloud-based AI engine using webhooking to facilitate a tutoring session.

12. A system according to step 11, wherein the student excused code is a natural language communication.

13. A system according to claim 12, further comprising:
a. a plurality of course modules stored in the cloud-based relational database, wherein each one of the plurality of course modules includes at least one course objective;
b. a plurality of distinct quiz questions, wherein each one of the plurality of distinct quiz questions is assigned to at least one of the at least one course objectives;
c. a distinct quiz answer assigned to each one of plurality of distinct quiz questions, wherein the first classroom computer generates a select course module signal, wherein the select course module signal corresponds to at least one of the plurality of course modules;
d. wherein the cloud-base processor receives the generated select a course module signal and retrieves at least one of the plurality of course modules from the cloud-based relational database which corresponds to the generated select a course module signal;
e. wherein the cloud-based processor provides the retrieved at least one of the course modules including the at least one course objective to the second classroom computer;
f. wherein the second classroom computer provides the at least one course objective to the projector, wherein the projector displays the at least one course objective to be seen by a plurality of students;
g. wherein the first classroom computer selects at least one of the plurality of learning objectives upon which to quiz the plurality of students;
h. wherein the first classroom computer selects at least one of the plurality of distinct quiz questions corresponding to the selected one of the at least one of the plurality of course objectives and provides the selected one of the plurality of distinct quiz questions to the projector, wherein the projector displays the selected one the plurality of distinct quiz questions for the plurality of students to see;
i. wherein the timer counts down from a predetermined time to a zero time when projector displays the selected one of the plurality of distinct quiz questions;
j. wherein at least one of the plurality of mobile devices provides a quiz response data to the cloud-based processor via webhook before the timer counts down to zero time;
k. wherein the cloud-based processor provides the received quiz response data to the cloud-based AI engine.

14. A system according to claim 13, wherein the cloud-based AI engine compares the received quiz response data to the stored quiz answer assigned to the selected one of the plurality of quiz questions and produces a quiz comparison result, wherein the cloud-based AI engine provides the quiz comparison result to the cloud-based relational database, and wherein the cloud-based AI engine provides the quiz comparison result to the first classroom computer.

15. A system according to claim 14, wherein the cloud-based AI engine prepares a personalized quiz tutoring plan when the quiz comparison result indicates that the quiz answer assigned to the selected one of the plurality of quiz questions does not match the received quiz response data, wherein the cloud-based AI engine provides the personalized quiz tutoring plan to the/at least one of the plurality of mobile devices that provided the received quiz response data.

16. A system according to claim 15, wherein the at least one of the plurality of mobile devices that provided the received quiz response data provides natural language communication via webhook to initiate a personalized quiz tutoring session relative to the personalized quiz tutoring plan.

17. A system according to claim 16, wherein the cloud-based relational database stores a plurality of brainstorming modules, wherein the plurality of brainstorming modules includes a plurality of distinct brainstorming questions.

18. A system according to claim 17, wherein the first classroom computer sends a select brainstorming module signal to the cloud-based processor, wherein the first computer sends a brainstorming question signal to the cloud-based AI engine, wherein the cloud-based AI engine generates a brainstorming question in response to the receiving the brainstorming question signal, wherein the cloud-based AI engine generates the brainstorming question relative to at least one of the distinct brainstorming questions.

19. A system according to claim 18, wherein the cloud-based AI engine provides the generated brainstorming question to the second classroom computer, wherein the second classroom computer provides the brainstorming question the projector.

20. A system according to claim 19, wherein the at least one of the plurality of mobile devices provides a brainstorming question answer to the cloud-based processor via webhook.

21. A system according to claim 20, wherein the cloud-based processor provides the brainstorming question answer to the second classroom computer, wherein the second classroom computer provides the brainstorming question answer to the cloud-based processor, wherein the second classroom computer provides the brainstorming question answer to the projector.

22. A system according to claim 21, wherein the first classroom computer provides a plurality of learning course modules to the cloud-based processor, wherein the cloud-based processor provides the plurality of learning course modules to the cloud-based relational database, wherein the cloud-based relational database stores the plurality of learning course modules, wherein each one of the plurality of learning modules includes at least one learning course objective, wherein each one of the plurality of learning course objectives includes at least one learning course quiz question, and wherein each one of the learning course quiz questions is assigned at least learning course objective question answer.

23. A system according to claim 22, wherein the first classroom computer generates a select learning course module signal and provides the generated select learning course module signal to the cloud-based processor, wherein the select learning course module signal corresponds to at least one of the stored plurality of learning course modules.

24. A system according to claim 23, wherein the cloud-based processor retrieves from the cloud-based relational database at least one of the plurality of learning course modules corresponding to the select learning course module signal, wherein the cloud-based processor provides the retrieved at least one of the plurality of learning course modules including the at least one learning course quiz questions to the first classroom computer.

25. A system according to claim 24, wherein the first classroom computer selects a first learning question and a second learning question from the at least one of the plurality of learning course modules, wherein the first classroom computer provides the selected first learning question to a first one of the plurality of mobile devices via webhook, and wherein the first computer provides the second learning question to a second one of plurality of mobile devices via webhook, where the first learning question is distinct from the second learning question.

26. A system according to claim 25, wherein the timer counts down from a predetermined time to a zero time when the first classroom computer provides the selected first learning question to the first one of the plurality of mobile devices and when the first classroom computer provides the selected second learning question to the second one of the plurality of mobile devise.

27. A system according to claim 26, wherein the first one of the plurality of mobile devices provides a learning objective response to the cloud-based processor via webhook before the time counts down to zero time, wherein the learning objective response corresponds to the first learning question.

28. A system according to claim 27, wherein the cloud-based processor provides the received learning objective response to the cloud-based AI engine, wherein the cloud-based AI engine compares the learning objective response to the selected first learning question to produce a learning objective comparison response.

29. A system according to claim 28, wherein the cloud-based processor provides the learning objective comparison response to the cloud-based AI engine, wherein the cloud-based AI engine generates a learning objective tutoring plan relative to the learning objective comparison.

30. A system according to claim 29, wherein the cloud-based AI engine provides the learning objective tutoring plan to the first one of the plurality of mobile devices via webhook.

31. A system according to claim 1, further including:
a. a third classroom computer for generating a second take attendance signal, wherein the third classroom computer is located inside a second classroom, wherein the cloud-based processor receives the second take attendance signal, the cloud-based processor generating a second confirm attendance code in response to the second take attendance signal, wherein the cloud-based artificial intelligence (AI) engine receives the second confirm attendance code, wherein the cloud-based artificial intelligence engine generates a second attendance check code in response to receiving the second confirm attendance code;
b. a third classroom computer for receiving the attendance check code, wherein the third classroom computer provides the second attendance check code;
c. a second projector for receiving the second attendance check code and displaying the second attendance check code to be visually seen by a second plurality of students in the second classroom;
d. a second timer for counting down time from a predetermined time to zero time when the second attendance check code is displayed;
e. a second plurality of mobile devices for providing a second distinct plurality of responding attendance check codes to the cloud-based processor before the second timer is at zero time, wherein each one of the second plurality of mobile devices provides the second distinct one of the plurality of attendance check codes to the cloud-based processor, wherein at least one of the second plurality of mobile devices is being activated by a distinct one of the second plurality of students in the classroom to send the second distinct one of the plurality of responding attendance check codes, wherein the cloud-based processor compares the second distinct one of the plurality of responding attendance check codes to the second attendance check code to produce a second comparison result, wherein the cloud-based relational database for receives the second comparison result and stores the second comparison result in the cloud-based relational database, wherein the cloud-based relational database includes at least one storage area corresponding to the each one of the second plurality of students in the second classroom, wherein storing the second comparison result includes storing the second comparison result in a distinct storage area of the cloud-based relational database corresponding to at least one of the second plurality of students in the classroom, wherein the cloud-based processor aggregates the first comparison result and the second comparison result into an aggregated comparison result, wherein the cloud-based relational database receives the aggregate comparison result and stores the aggregate comparison result in the cloud-based relational database, wherein storing the aggregate comparison result includes storing the aggregate comparison result in the distinct storage area of the cloud-based relational database corresponding to the at least one of the second plurality of students in the classroom.
